(19) United States
(12) Patent Application Publication
(10) Pub. No.: US 2004/0152458 A1
(43) Pub. Date: Aug. 5, 2004

(54) Data transfer method in mobile communication system and mobile communication system

(76) Inventor: Ari Hottinen, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/434,462

(22) Filed: May 9, 2003

Related U.S. Application Data
(60) Provisional application No. 60/443,570, filed on Jan. 30, 2003.

(51) Int. Cl. H04Q 7/20

(52) U.S. Cl. 455/423; 455/517; 455/436

(57) ABSTRACT

A data transfer method and a mobile communication system is provided. The mobile communication system includes a first radio system, a second radio system and user equipment operationally connected to both radio systems. According to the invention, a portion of the control information generated for radio resource control of the first radio system is signalled between the user equipment and the first radio system, using the second radio system. The invention enables, for example, using closed-loop radio resource control schemes in radio systems with insufficient signalling resources.

### CROSS-REFERENCE TO RELATED APPLICATIONS

This application claims priority to U.S. Provisional Application Serial No. 60/443,570, filed Jan. 30, 2003, the entire contents of which are incorporated herein by reference.

### BACKGROUND OF THE INVENTION

1. Field of the Invention

The invention relates to a data transfer method in a mobile communication system, and a mobile communication system.

2. Description of the Related Art

As mobile communication becomes more widely used and the capacity requirement increases rapidly, new radio system generations are launched. In the meantime, performance of the existing radio systems is improved by upgrading their signal transmission and reception methods.

A drastic limitation in improving the performance of the existing systems is caused by a shortage of signalling resources, such as feedback channels, which can be used in the radio resource adjustment of a base station. The shortage may arise from, for example, low signalling speed compared to the radio channel variation or total absence of the signalling resources.

### SUMMARY OF THE INVENTION

It is an object of the invention to provide a method and an arrangement wherein the limitations of the signalling resources to the performance of a mobile communication system are reduced. This is achieved by a data transfer method in a mobile communication system comprising a first radio system and a second radio system operationally connected to the first radio system, and user equipment operationally connected to the first radio system and the second radio system, the method comprising the steps of: generating control information for radio resource control of the first radio system; and signalling at least a portion of the control information between the user equipment and the first radio system, using the second radio system.

The invention also relates to a mobile communication system comprising a first radio system comprising a primary base station for providing radio resources for the first radio system; a second radio system operationally connected to the first radio system, the second radio system comprising a signal base station for providing radio resources for the second radio system; and user equipment comprising a transceiver for radio transmission and reception with the first radio system and the second radio system; a generator for generating control information for radio resource control of the first radio system; and wherein the transceiver and the signal base station are arranged to signal at least portion of the control information between the user equipment and the first radio system.

The method and the system of the invention provide several advantages. In an aspect, the invention enables adaptivity in radio resource control in systems with insufficient signalling resources.

The invention is based on coordinated use of at least two radio systems so that a radio system can dynamically use the signalling and transmission resources of the other.

### BRIEF DESCRIPTION OF THE DRAWINGS

In the following, the invention will be described in greater detail with reference to the preferred embodiments and the accompanying drawings, in which:

FIG. 1 shows an example of a mobile communication system by means of a block diagram;

FIG. 2 shows another example of a mobile communication system by means of a block diagram;

FIG. 3 shows an example of a structure of user equipment;

FIG. 4 shows embodiments of the invention by means of a flow chart; and

FIG. 5 shows embodiments of the invention by means of a flow chart.

### DETAILED DESCRIPTION OF THE PREFERRED EMBODIMENTS

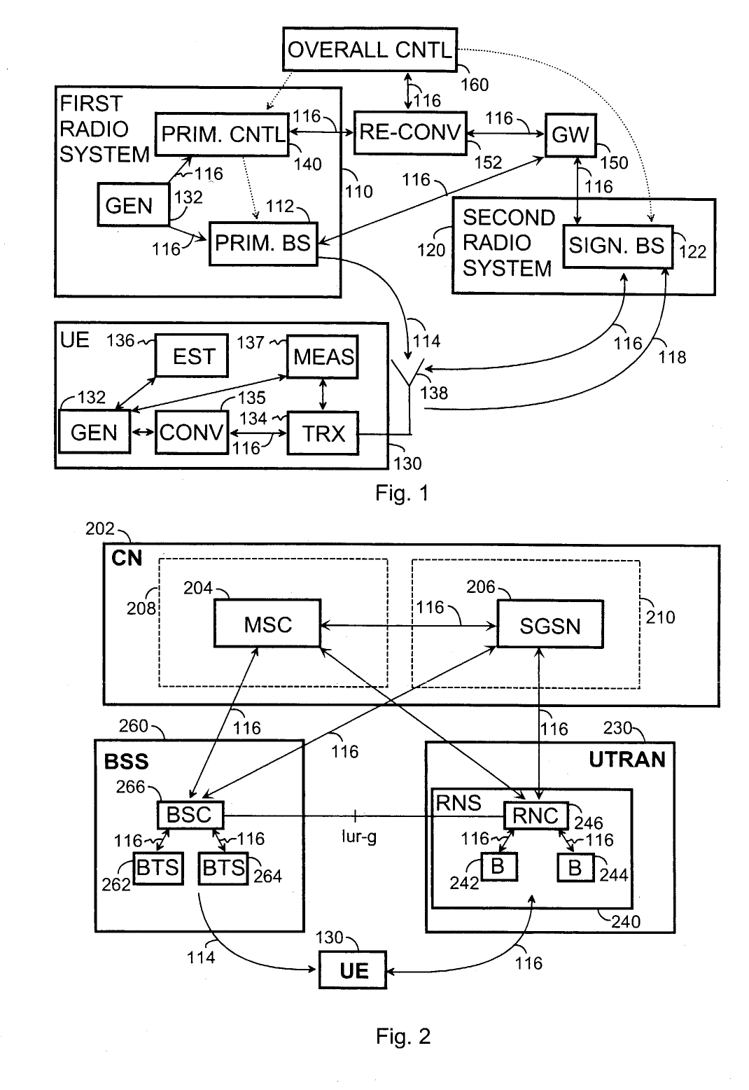

With reference to FIG. 1, examine an example of a mobile communication system to which the present invention can be applied. The mobile communication system comprises a first radio system 110, a second radio system 120 operationally connected to the first radio system 110, and user equipment 130 capable of connecting to both radio systems 110, 120. In general, a radio system is a generic mobile communication system that uses a radio access technology.

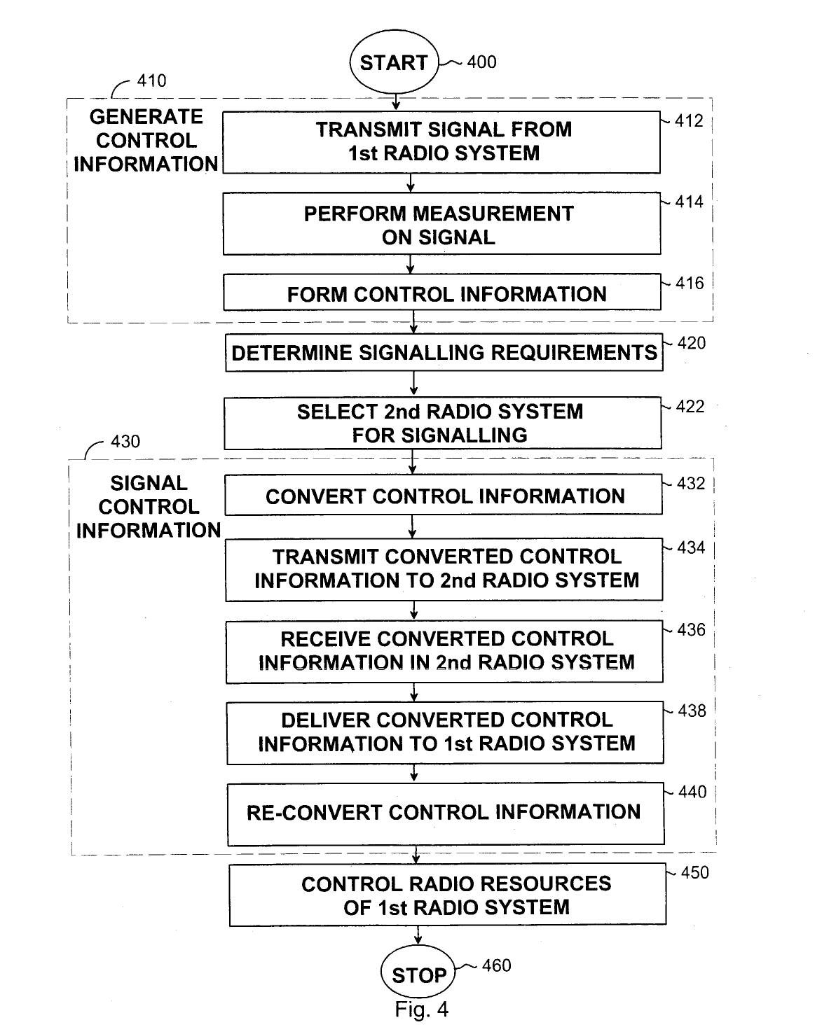

With reference to FIG. 4, consider the method according to an embodiment of the invention by means of a flow chart. In Start block 400, the method is started. In block 410, the control information 116 for the radio resource control of the first radio system 110 is generated. In Block 430, a portion of the generated control information 116 is signalled between the user equipment 130 and the first radio system 110 using the second radio system 120. In block 460, the method ends.

With further reference to FIG. 1, the first radio system 110 comprises a primary base station 112 for providing radio resources, such as transmission and reception, for the user equipment 130. The first radio system 110 may have or may not have a feedback channel to the user equipment 130.

The user equipment 130 comprises a generator 132 connected to the transceiver 134, and an antenna 138 connected to the transceiver 134. The generator 132 is implemented, for example, with the processor of the user equipment 130 and a software application.

In an embodiment of the invention, the portion of the control information 116 is signalled 430 from the user equipment 130 to the first radio system 110, using the second radio system 120. For this purpose, the user equipment 130 comprises a generator 132 for generating the control information 116 for radio resource control of the first radio system 110, and the transceiver 134 and the signal base station 122 are arranged to signal at least a portion of the control information 116 from the user equipment 130 and the first radio system 110.

In an embodiment, the portion of the control information 116 is signalled 430 from the first radio system 110 to the user equipment 130 using the second radio system 120. In this embodiment, the first radio system 110 comprises a generator 132 for generating 430 the control information 116 for the radio resource control of the first radio system 110, and the signal base station 122 is arranged to signal the portion of the control information 116 to the user equipment 130. The generator 132 can be implemented in the primary base station 112 or in the primary controller 140 with a software application.

The route of the signalled portion of the control information 116 is also shown in FIG. 1. The dashed lines illustrate the radio resource control signals generated from the signalled portion of the control information 116.

The control information 116 may include information concerned on establishment and control of connection, and management of the mobile communication system. The control information 116 may include, for example, information on the following quantities: a transmit antenna weight or a beam-forming matrix applied in the primary base station 112 when transmitting signals to the user equipment 130, a channel impulse response for a radio channel between the user equipment 130 and the primary base station 112, a filtered channel impulse response for a signal between the user equipment 130 and the primary base station 112, a signal-to-noise ratio for a signal between the user equipment 130 and the primary base station 112, a signal-to-interference ratio for a signal between the user equipment 130 and the primary base station 112, a signal-to-interference-and-noise ratio for a signal between the user equipment 130 and the primary base station 112, a message associated with acknowledgement of reception for a signal transmitted from the primary base station 112 to the user equipment 130, a channel quality indicator for a radio channel between the primary base station 112 and the user equipment 130, scheduling information, a time/code/frequency channel indicator, modulation and coding indicators, power control information, and rate control information.

Let us consider an example in which the first radio system 110 utilizes transmit antenna diversity in the downlink, and the invention is applied to the transmit diversity adjustment. Accordingly, the primary base station 112 is equipped with a multi-antenna array with M antenna elements, each of which can be weighted independently with antenna weights.

Let us assume that the user equipment 130 has measured a temporal channel estimate vector Hₚ represented by

Hₚ=[h₁^{p},h₂^{P}, . . . ,h_{M}^{p}], (1)

wherein h₁^{p} is a complex channel estimate for transmit antenna m for a temporal tap p. The channel estimate hₘ^{p} is a digitized impulse response, for instance. The portion of the control information 116 to be signalled 430 from the user equipment 130 to the first radio system 110 can be formed from the channel estimate vector Hₚ in different ways. In an embodiment of the invention, the control information 116 includes at least one digitised channel estimate hₘ^{p}. In an embodiment of the invention, a correlation matrix R is formed using the channel estimate vector Hₚ yielding

$$R = \frac{1}{P} {\sum }_{p = 1}^{p} {H}_{p}^{H} {H}_{p} , \qquad ( 2 )$$

wherein P is the number of the channel taps and Hₚ^{H} is a Hermitian conjugate of the channel estimate vector Hₚ. The information of the correlation matrix can be crystallized in eigenvalues and eigenvectors, indicated with [11, 11, . . . , 1N] and Wₙ=(Wₙ₁, Wₙ₂, . . . , W_{NM}), respectively, of the correlation matrix R. Each eigenvalue 1n represents the average receive power of the user equipment 130 for the eigenvector Wₙ, also called a diversity vector or an eigenbeam, which represents the transmit antenna weighting. The eigenvalues and the corresponding eigenvectors can be obtained, for example, with diagonalization procedures, such as a singular value decomposition (SVD), joint approximate matrix diagonalization, Cholesky factorisation, or other relevant numerical procedures known to a person skilled in the art. These can also be obtained by adaptive updating procedures, where the channel correlation matrix need not be calculated at all.

The diversity vectors Wₙ are possibly quantized at the transmitting unit being substantially mutually orthogonal and enabling a favourable transmit diversity when used in antenna weighting. In an embodiment of the invention, at least one eigenvector Wₙ is generated 410 in the user equipment 130 and signalled 430 from the user equipment 130 to the first radio system 110 using the second radio system 120. The diversity vectors corresponding to the signalled eigenvalues/eigenvectors can be obtained numerically in the first radio system 110. In another embodiment of the invention, at least one element Wₙₘ of an eigenvector Wₘ is generated 410 and signalled 430 to the first radio system 110 using the second radio system 120.

The procedure associated with the transmit diversity adjustment according to the invention can also be applied to MIMO systems (Multiple Input Multiple Output), wherein the transmission and reception are performed using a multi-element antenna array. In the MIMO case, the channel estimate vector Hₚ given in Equation (1) is replaced with a channel estimate matrix, whose element represents a channel estimate corresponding to a transmission-reception antenna element pair. The correlation matrix R, eigenvectors and the eigenvalues In can be obtained in the manner described above. It is also possible that the correlation matrix, or a quantized representation of the correlation matrix, is signalled to the transmitting unit. The feedback information may in addition incorporate signalling information for transmit power, adaptive modulation and coding, coding parameters, and space-time coding parameters.

It should be noted that the control information 116 can be represented in any manner known to a person skilled in the art as long as the relevant information is transferred from the user equipment 130 to the first radio system 110. For example, when a vector or a matrix representation of the control information 116 is used, any transformed and/or truncated form of the control information 116 generated 410 can be used in signalling 430. The control information 116 can further be quantized according to the quantization rules of the radio systems 110, 120.

In an embodiment of the invention, the control information 116 carries information on relative difference between the radio resource control parameters signalled 430 in two successive signalling steps. For example, a case may occur where the difference between diversity vectors in two successive signalling steps is signalled instead of the absolute values of the diversity vectors. Various hierarchic or progressive updating procedures are also possible, where the bit signalled a time t depends on at least one previous signalling bit transmitted before time t. The transceiver 134 is arranged to signal the control information 116, using the second radio system 120. The arrangement includes, for example, selecting a radio channel from a radio system, such as a physical or a logical channel, suitable for signalling purposes. The transceiver 134 comprises, for example, a multiplexing unit for multiplexing the signal carrying the control information 116, a power amplifier for amplifying the antenna signal, and a modulator for modulating the base band signal into radio frequency.

The second radio system 120 comprises a signal base station 122 for forming a signalling link for the control information 116 from the user equipment 130 to the first radio system 1110. The second radio system 120 is operationally connected to the first radio system 110 so that the control information 116 transmitted by the user equipment 130 can be conveyed to the first radio system 110.

The operational connection includes, for example, capability of transforming the format of the control information 116 from a format suitable for second radio system 130 into a format suitable for the first radio system 110, and vice versa. The physical connection between the two radio systems 110, 120 can be implemented with a galvanic arrangement, optical arrangement, or a radio arrangement. Furthermore, the operational connection may include capability of routing the signal carrying the control information 116 to a correct destination, such as the primary base station 112, and identifying the control information 116 so that the control information 116 can be associated with an appropriate radio channel.

The two radio systems 110, 120 may have a housing in common, possibly sharing at least part of the equipment, such as power supply, radio frequency parts, and antenna elements. In an embodiment of the invention, the second radio system 120 utilizes different radio access technology from that used by the first radio system 110.

The signal base station 122 is arranged to participate in signalling from the user equipment 130 to the first radio system 110. The arrangement includes, for example, transmitting control signals to the user equipment 130 for establishing a radio link between the signal base station 122 and the user equipment 130, and receiving a signal carrying the control information 116 transmitted by the user equipment 130.

The user equipment 130 is operationally connected to the first radio system 110 and the second radio system 120. The operational connection includes, for example, capability of establishing a radio link between the user equipment 130 and the two radio systems 110, 120. A third radio system not shown in FIG. 1 can also be involved parallel to either the first 110 or the second radio system 120. That is, said third radio system may use the second radio system 120 for signalling purposes, or the first radio system 110 may use the third radio system for signalling purposes according to the invention. The user equipment 130 supporting more than one radio system are known to a person skilled in the art, and only those details relevant to the present solution are described. In the prior art solutions, the multi-standard transceivers operate using only one kind of radio access technology, with the possible exception during handover from one to the other. These solutions, however, are intended to provide a smooth handoff from one to another, rather than increasing the control signalling capacity of the first radio connection in particular when handover is not triggered.

In an embodiment of the invention, the downlink radio resources of the first radio system 110 are controlled 450 using the control information 116. The mobile communication system comprises a primary controller 140 connected to the first radio system 110 and the second radio system 120 for controlling downlink radio resources of the first radio system 110 using the control information 116. The control information 116 can affect the radio resource control directly, i.e. the radio resource control uses the control information 116 as such, or the control information 116 is used as an information source when adjusting the radio resource parameters. The control information 116 is signalled 430 to the primary controller 140 from the signal base station 122. Then control information 116 is interpreted and the tasks according to the control information 116 are performed. The primary controller 140 can be partly or entirely integrated with the primary base station 112. Some tasks can be performed in higher layers of the mobile communication system. The tasks the radio resource control, here understood in a wide sense, may include: beam forming, transmitter diversity adjustment, MIMO (multiple input multiple output) channel adjustment, power control for at least one parallel stream, data rate adjustment for at least one parallel stream, prioritisation of user transmission, routing allocation, multi-user scheduling, space-time modulation selection, modulation and coding selection, handover connection establishment, code allocation, frequency allocation, and ARQ process control.

In beam forming, the control information 116 includes, for example, information on the beam-specific channel estimates for the radio channels associated with antenna beams of the primary base station 112. After receiving the control information 116, the first radio system 110 may select the most favourable portion of the cell for the transmission and possibly reception for the user equipment 130 based on the received control information 116. The first radio system 110 can further instruct the user equipment 130 to tune in to the channel corresponding to the most favourable portion of the cell. The tuning includes, for example, selecting an appropriate frequency and possibly modulation coding.

In transmit diversity adjustment, the control information 116 includes, for example, at least a portion of diversity vector. After receiving the transmit diversity vector, the primary base station 112 loads an appropriate portion of the diversity vector to the beam forming matrix, which weights the antenna signals accordingly.

In scheduling, the first radio system 110 prioritises the user equipment 130 in the cell area, and schedules the transmission and reception accordingly. The control information 116 includes a status report generated by the user equipment 130. In dynamic channel allocation, the radio resources, such as beams, time-slots, frequency-slots, spreading code, and carrier, are allocated using at least part of the control information 116. The status report may comprise a channel quality indicator from one or more than one user, and the user with better channel conditions may be prioritised.

In data rate adjustment, the first radio system 110 adjusts the data rate directed at the user equipment 130 according to the channel state or quality information carried by the control information 116. In an embodiment, the primary base station 112 uses the minimum required transmission resources, such as transmit power, needed to meet the target quality-of-service needs. The parameter determining the data rate may be determined at the primary base station 112 using the side information signalled by the user equipment 130. The transmission data rate may, for example, be increased when the channel quality increases.

In an embodiment of the invention, the control information 116 is generated 410 by transmitting 412 a signal 114 from the first radio system 110 to the user equipment 130, performing 414 a measurement on the signal 114 in the user equipment 130, and forming 416 the control information 116 in the user equipment 130 using the measurement. The signal 114 is generated in the primary base station 112 and transmitted using the radio transceiver of the primary base station 112. The signal 114 may include a predetermined symbol sequence, called a pilot sequence or a training sequence, to which the measurement is subjected. The pilot sequences can also be orthogonal to each other. The pilot sequence can be transmitted using common pilot channels dedicated to pilot signalling of the first radio system 110. The pilot sequence can also be transmitted in the traffic channels so that dedicated bits in each time slot are allocated for the pilot sequence. For example, in a GSM/EDGE system, the pilot sequence includes 26 symbols in the middle of the EDGE burst.

In an embodiment of the invention, the primary base station 112 comprises an antenna array with at least two antenna elements. The signal 114 is transmitted using the antenna elements so that the antenna element-specific portions of the signal 114 are separable from each other. In a broader interpretation of an antenna element, an antenna element comprises elementary antennas. The separation between the antenna-element-specific portions of the signal can be obtained, for example, with orthogonality between the antenna element-specific signals. The orthogonality can be obtained, for example, with antenna element-specific coding, orthogonal antenna weighting, or antenna hopping pilot sequences. In orthogonal antenna weighting, signal 114 is transmitted with successive bursts so that each burst is transmitted with antenna weighting orthogonal to antenna weighting corresponding to any other burst. Then, the antenna element-specific portion of the signal 114 can be obtained by combining the information obtained from the bursts.

The measurement on the signal 114 is performed in the measurement unit 137 of the user equipment 130. In general, the measurement provides information associated with a radio channel impulse response between the primary base station 112 and the user equipment 130. The elementary quantity obtained in the measurement is usually associated with the energy or phasing of the signal 114. The measurement can yield information on the following quantities: impulse response for the signal 114, averaged channel impulse response for the signal 114, signal-to-noise ratio for the signal 114, signal-to-interference ratio for the signal 114, signal-to-interference-and-noise for the signal 114, frame error rate, and packet error rate. Also derived parameters, such as coding and modulation parameters needed to meet a given packet error rate, and parameters for selected channel resources, such as beams and carriers, can be considered as measurement quantities.

In an embodiment of the invention, the control information 116 is signalled 430 by converting 432 a portion of the control information 116 into format suitable for the second radio system 120, transmitting 434 the converted portion of the control information 116 from the user equipment 130 to the second radio system 120, receiving 436 the converted portion of the control information 116 in the second radio system 120, delivering 438 the converted portion of the control information 116 from the second radio system 120 to the first radio system 110, and re-converting 440 the converted portion of the control information 116 into a format suitable for the first radio system 110.

The user equipment 130 comprises a converter 135 connected to the generator 132 for converting the portion of the control information 116 between the format of the first radio system 110 and the format of the second radio system 120. The format conversion 432 includes, for example, coding and multiplexing the control information 116 so that the information content of the control information 116 can be transferred using a chosen radio channel of the second radio system 120. The coding includes, for example, mapping the control information 116 onto a suitable physical channel. The format conversion 432 also includes providing the signal carrying the control information 116 with an address tag, which links the control information 116 to a correct radio channel between the user equipment 130 and the primary base station 112. The transceiver 134 selects, for example, an appropriate radio frequency band for control information transmission. If the packet data transfer is used, the processor of the user equipment 130 forms a data stream that includes the control information 116.

The converted control information 116 is transmitted 434 from the transceiver 134 to the second radio system 120, and received 436 in the signal base station 122. The transmission and reception can be performed using the known procedures of the second radio system 120. Alternatively, a specific procedure can be set up to simplify the transmitter. For example, if the first radio system 110 uses time-division multiple-access, the control information 116 may be transmitted using the transmission resources of the second radio system 120 when the transmission power allocated for the first radio system 110 is off, ie. when the slot is allocated to another user, as this requires only one radio frequency unit for transmission.

After the control information 116 has been received 436, the control information 116 is delivered to a gateway 150 connected to the first radio system 110 and the second radio system 120. The gateway 150 acts as a link between the first radio system 110 and the second radio system 120. The gateway 150 includes delivering means for the physical or logical signal carrying the control information 116. The delivering means include, for example, cabling, radio transceivers, and switches. The gateway 150 also includes digital processors and software for forming interfaces between the two radio systems 110, 120 and implementing data transfer protocols. The gateway 150 can be included in the signal base station 122, the base station controller controlling the signal base station 122, a mobile switching center (MSC) connected to the first radio system 110 and the second radio system 120, the primary controller 140 controlling the primary base station 112, or the primary base station 112. It should be noted that the physical location of the gateway 150 is not relevant to the invention as long as the signalling requirements are fulfilled.

After delivering 438 the converted control information 116 to the first radio system 110, the control information 116 is re-converted 440 into format of the first radio system 110 in a converter 152. The converter 152, for example, interprets the bits in the data packet carrying the control information 116 so that the control information 116 is transformed into the first radio system 110 format and the radio resource control is directed at the correct radio channel. The converter 152 is connected to the first radio system 110 and the second radio system 120 via gateway 150, for example. The converter 152 can be situated in the primary controller 110, the primary base station 112, or the overall controller 160.

In an embodiment of the invention, the control information 116 is signalled 430 from the user equipment 130 to the first radio system 110 using an uplink feedback channel of the second radio system 120. In general, the feedback channels are designed for the closed-loop-type radio resource control of the second radio system 130. The capacity of the feedback channel and the delay in conveying the control information 116 from the user equipment 130 to the second radio system 130 are usually designed according to the radio resource control requirements of the second radio system 120. The radio resource control requirements define, for example, the minimum delay between a moment of generating 410 the control information 116 and a moment of the control information 116 being realized as a radio resource control procedure. The feedback channel can be a common or a dedicated uplink channel.

In an embodiment of the invention, a specific feedback channel is established in the second radio system 130 for signalling 430 the control information 116 of the first radio system 110. For example, the FBI field in the uplink signalling frame in the WCDMA system may be used to signal feedback information intended for the GSM system, for example, when requested by the primary base station 112. Alternatively, the feedback information can be multiplexed in the multi-service uplink frame of the WCDMA system, in a similar manner to when any other source with service specific rate and quality requirements are multiplexed.

In an embodiment of the invention, the feedback channel for signalling 410 is selected in the second radio system 120 so that the signalling associated with the radio resource control of the second radio system 120 and the user equipment 130 is minimized. For example, in UTRAN, the 3GPP specification defines several states of the radio resource control with different signalling requirements. For example, in the CELL_DCH state (DCH, Dedicated Traffic Channel) a dedicated connection to both transmission directions is allocated to the user equipment 130. The procedures to maintain the dedicated connection involve signalling between the user equipment 130 and the second radio system 120, and therefore the CELL_DCH state of the radio resource control of the second radio system 120 might not be an optimal choice for the present invention. On the contrary, the CELL_FACH (FACH, Forward Access Channel) state has no dedicated traffic channel, but data can still be transferred via common channels. This state is particularly suitable for packet-switched connections. The use of common channels preserves the radio resources of the cell of the second radio system 129. In the uplink direction, small data packets and control signals can be sent on RACH (Random Access Channel) or CPCH (Common Packet Channel).

In an embodiment of the invention, the control information 116 is signalled 430 using packet switched data transfer. The data stream is generated in the generator 132 of the user equipment 130 and transmitted by the transceiver 134 to the signal base station 122. The packet switched data transfer provides a flexible way of signalling the control information 116 since the packet switched data transfer can be realized using the existing data transfer procedures, thus enabling the implementation without changes in the technical specification, such as the 3GPP specification. The packet data transfer procedures include, for example, routing the control information 116 to the correct destination and coding the control information 116 in the data stream in a favourable manner. The implementation of the invention is straightforward when implemented in an existing mobile communication system that supports packet data transfer.

In an embodiment of the invention, the control information 116 is mapped into a traffic channel of the second radio system 120. The mapping can be implemented in the modulation and multiplication phase of the signal processing. For example, each WCDMA frame can include a portion of the control information 116.

In an embodiment of the invention, the signalling requirements, such as signalling capacity and response time, are determined 420 before signalling 430, and the second radio system 120 is selected for signalling 410 based on the determined signalling requirements. The first radio system 110 may also have a radio channel for signalling, but the capacity, response time or other limiting property of the signalling channel prevents an efficient use of the radio resource control. In such case, an assessment is made whether the signalling route of the first radio system 110 or that of the second radio system 120 is to be used. The assessment can be done with the signalling requirement determination. The signalling requirement determination can also be utilized when an appropriate channel of the second radio system 120 is selected for signalling 430.

The signalling requirements also include the order in which the components of the control information 116 are transmitted from the user equipment 130 to the second radio system 120. The components of the control information 116 can be prioritised according to the response of the performance of the mobile communication to the control associated with each component of the control information 116. For example, when the control information 116 includes eigenvectors of a correlation matrix, the eigenvectors associated with the largest eigenvalues are prioritised with the highest priority. As a result, the radio resource control adjusts first those transmit antenna weights that have the greatest impact on the diversity gain. In a multi-user case, those users with the largest eigenvalues or SNR may be prioritised over those with worse SNR, for example.

The determination of the signalling requirements can be based on the control information 116 generated in the generator 132 of the user equipment 130. The signalling requirements are determined in an estimator 136 connected to the generator 132 in the user equipment 130. The selection between the radio systems 110,120 is carried out in the estimator 136. The estimator 136 returns an index for the selected feedback route to the generator 132, which directs the control information 116 accordingly. The estimator 136 can be implemented, for example, with a software application in the processor of the user equipment.

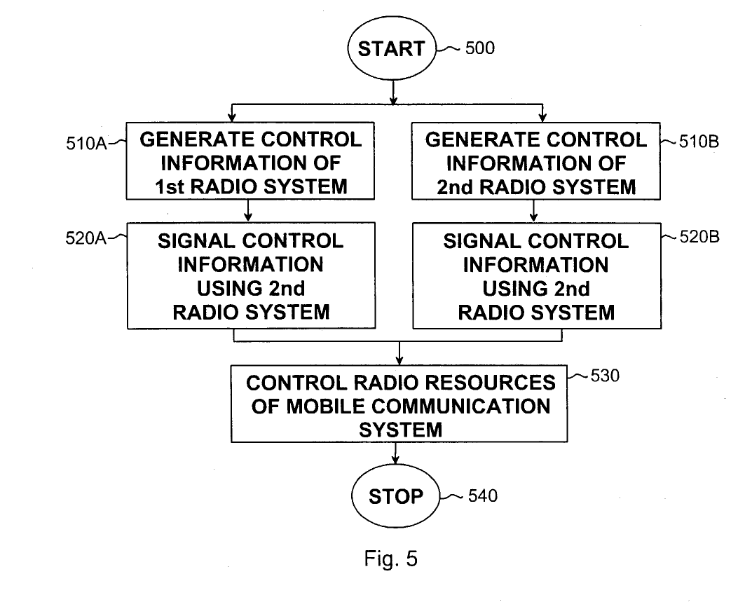

With reference to FIG. 5, let us consider an embodiment of the invention wherein, after start 500, control information 118 for the radio resource control of the second radio system 120 is generated 510B, the control information 118 for the radio resource control for the second radio system 120 is signalled 520B using the second radio system 120, and the radio resources of the mobile communication system are controlled 530 by an overall controller 160 using the control information 116 generated for the first radio system 110 and the control information 118 generated for the second radio system 120. For example, the overall controller 160 can assess whether to use the first radio system 110 or the second radio system 120 when allocating radio resources to the user equipment 130. The control information can be generated, for example, by performing measurements, such as inter-frequency measurements, on the signals transmitted from the first radio system 110 and the second radio system 120. The blocks 510A and 520A correspond to blocks 410 and 430, respectively, shown in FIG. 4. In block 540, the method ends.

With reference to FIG. 2, let us consider an example of a mobile communication system to which the invention can be applied. The structure and the functions of the network elements are only described when relevant to the invention.

The first radio system 110 and the second radio system 120 shown in FIG. 1 are represented in FIG. 2 by a base station system (BSS) 260 and a UMTS Terrestrial Radio Access Network (UTRAN) 230, respectively. In the current example, the base station system 260 is implemented with a GERAN (GSM/EDGE radio access technology). The UTRAN 230 is implemented with a wideband code division multiple access (WCDMA) technology. The invention is not limited to those radio access technologies, but it can also be applied to the following radio access technologies: GSM (Global System for Mobile Communications), GPRS (General Packet Radio Service), E-GPRS (EDGE GPRS), CDMA2000 (CDMA, Code Division Multiple Access), US-TDMA (US Time Division Multiple Access), and IS-95. The abbreviations used are the following: UMTS, Universal Mobile Telecommunications System; GSM, Global System for Mobile Communication; EDGE, Enhanced Data Rates for Global Evolution.

The GERAN is based on a GSM technology, whose uplink signalling resources are rather limited, and therefore, the recent improvements in the GERAN have been restricted to the open-loop scheme, such as delay diversity, antenna hopping, and phase hopping, which can be implemented using the current GSM standard. The potential gain using closed-loop schemes, such as transmit diversity scheme, has been evaluated in article “Transmit Diversity With Fast Reverse Channel for EDGE” by G. P. Mattellini and P. A. Ranta, proc. IEEE International Conference on Telecommunications, ICT2001, June 2001 Bucharest, which is thereby incorporated by reference.

In an embodiment of the invention, the first radio system 110 utilizes an HSDPA (High Speed Downlink Packet Access) type concept, using the GSM/EDGE radio access technology. The HSDPA is considered here as a generic term that refers to data transmission protocols that bring high-speed data delivery to user equipment, in analogy with WCDMA Release 5 specification. To support HSDPA, protocols such as AMC (Adaptive Modulation and Coding) and HARQ (Hybrid Automatic Retransmission Request) have been proposed, which protocols require fast feedback channels.

The AMC is a protocol for adapting the modulation and coding format based on a measurement carried out by the user equipment 130 and a channel state between the base transceiver station 262, 264 and the user equipment 130 to increase the use efficiency of an entire cell. The AMC protocol involves a group of modulation and coding schemes, thus providing an adaptive selection of modulation and coding protocols according to the channel condition between the user equipment 130 and the base station 262, 264. The control information 116 includes, for example, coding and modulation selections needed to meet the required or targeted service quality criteria with minimal transmit power.

The HARQ is associated with a retransmission request and a response to the retransmission request exchanged between the user equipment 130 and the base station system 260. In the HARQ protocol, the next packet data is not transmitted from the base transceiver station 262, 264 until a positive acknowledgement (ACK) signal for the previous transmitted packet data has been received. In turn, packet data can be successively transmitted without receiving the positive acknowledgement signal for the previous packet data, thereby increasing the use efficiency of channels. Also, a negative acknowledge signal (NACK) can be used. The ACK/NACK is formed based on the error detection procedures performed in the user equipment 130.

In an embodiment of the invention, the portion of the control information 116 signalled from the user equipment 130 includes a channel quality indicator (CQI). The CQI indicates radio transmission parameters, such as coding and modulation scheme, which the first radio system 110 preferably uses in order to meet a desired data rate.

In an embodiment, the control information 116 includes the information on acknowledgment of reception of a data packet.

The UTRAN provides an efficient second radio system 120, whose feedback time is 0.667 ms according to the 3GPP specification.

The mobile communication system comprises a core network 202, which can further be divided into a circuit-switched domain 208 and a packet switched domain 210. The circuit-switched domain 208 comprises circuit-switched network elements and the packet-switched domain 210 comprises packet-switched network elements.

As an example of a circuit-switched network element, a mobile services switching center (MSC) 204, also called a MSC server (MSS), is shown. The mobile services switching center 204 is the center point of the circuit-switched domain of the core network 204. The same mobile services switching center 204 can be used to serve the connections of the UTRAN 230 and the base station system 260. The tasks of the mobile services switching center 204 include: radio resource control, such as handover management, switching, paging, and user equipment 130 location registration. Also, the tasks of the gateway 150, the overall controller 160, and the converter 152 can be performed in the mobile services switching center 204 using a software application.

A serving GPRS support node (SGSN) 206 is the center point of the packet-switched side of the core network 202. The main task of the serving GPRS support node 206 is to transmit and receive packets together with the user equipment 130 supporting packet-switched transmission by using the radio access network 230 or the base station system 260. The serving GPRS support node 206 contains subscriber and location information related to the user equipment 130. The serving GPRS support node 206 can perform tasks of the gateway 150, the overall controller 160, the converter 152, and the primary controller 140. Especially, when the control information 116 is signalled using the packet switched data transfer, the control information 116 can be routed via the serving GPRS support node 206.

The base station system 260 comprises a base station controller (BSC) 266 and base transceiver stations (BTS) 262, 264. The base station controller 266 controls the base transceiver station 262, 264. The base station controller 266 is responsible for the following tasks, for instance: radio resource management of the base transceiver station 262, 264, inter-cell handovers, frequency allocation to the base transceiver stations 262, 264, management of frequency hopping sequences, implementation of the operation and maintenance interface, and power control. The primary controller 140, the converter 152 and the gateway 150 can be implemented, for example, in the base station controller 266 using a software application. The base station system 260 is connected to other radio systems, such as UTRAN and other base station systems, directly or via the mobile services switching center 204 and/or the serving GPRS support node 206.

The base transceiver station 262, 264 comprises at least one transceiver which implements the physical radio channel between the base station system 260 and the user equipment. Typically, one base transceiver station 262, 264 serves one cell, but a solution is also possible wherein one base transceiver station 262, 264 serves several sectored cells. The tasks of the base transceiver station 262, 264 include, for example: calculation of timing advance (TA), antenna weighting, channel coding, encryption, decryption, and frequency hopping.

The UTRAN 230 comprises a radio network subsystem 240. Each radio network subsystem 240 comprises a radio network controller (RNC) 246 and nodes B 242, 244. The node B implements the radio interface between the UTRAN 230 and the user equipment 130, and corresponds to the signal base station 122 shown in FIG. 1.

Operationally, the radio network controller 246 corresponds approximately to the base station controller 266 of the GSM system, and node B 242, 244 corresponds approximately to the base transceiver station 262, 264 of the GSM system. Solutions also exist in which the same device is both the base transceiver station and node B, i.e. the device is capable of implementing both the TDMA and WCDMA radio interfaces simultaneously. The radio network controller 246 may perform tasks of the gateway 150.

The UTRAN 230 and the base station system 260 can be situated in a common housing and share common components, such as power supply, radio transceivers and antennas. The control information 116 can be delivered from the UTRAN 260 to the base station system 260 using an Iur-g interface between the radio network controller 246 and the base station controller 266.

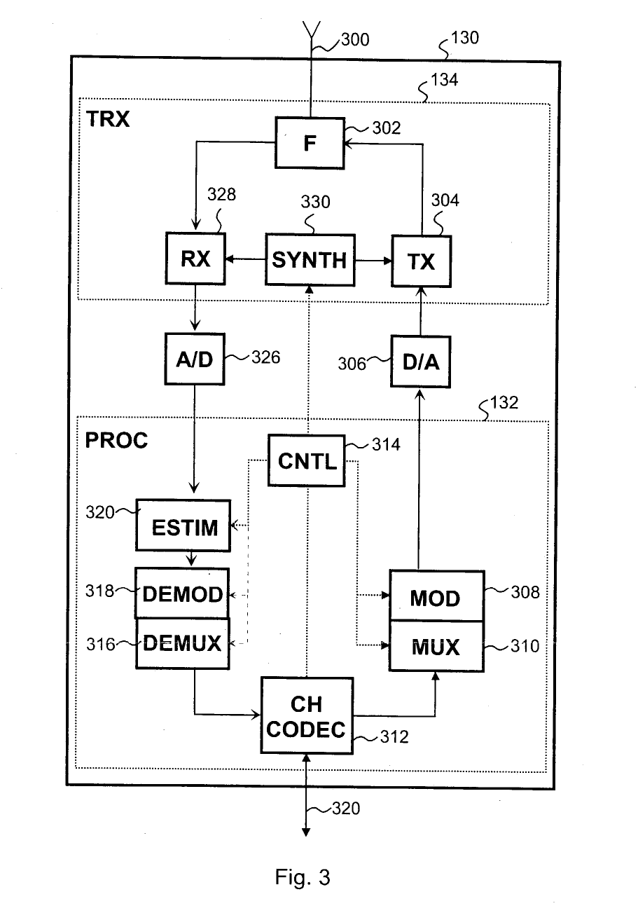

With reference to FIG. 3, consider a structure of the user equipment 130. The user equipment 130 comprises a processor 332 and a radio transceiver 334 connected to the processor 332. The processor 332 includes software suitable for the relevant tasks. The user equipment 130 further comprises an antenna 300 for signal transmission and reception, and a digital-to-analogue converter 306 for converting a digital signal to an analogue form and an analogue-to-digital converter 326 for converting an analogue signal to a digital form.

The transceiver 334 comprises a duplex filter 302 for separating the signals in transmission and reception directions from each other. The transceiver 334 also comprises a transmitter 304, a receiver 328, and a synthesizer 330. The synthesizer 330, for example, creates the required frequencies, for example by means of a voltage-controlled oscillator, and arranges the required frequencies in transmission and possibly reception.

In reception, a signal is taken from the antenna 300 to a duplex filter 302. Next, the signal is converted into a base band frequency, and the resulting signal is sampled in the analogue-to-digital converter 326. A channel estimator 320 performs the necessary measurement, such as channel estimation. A demodulator 318 takes a bit stream from the equalized signal, which bit stream is transmitted to a demultiplexer 316. The demultiplexer 316 separates the bit stream into separate logical channels, and performs the measurement tasks for the channel estimates. A channel decodec 312 decodes the bit stream of different logical channels, i.e. decides whether the bit stream is signalling information to be further transmitted to a control unit 314, or whether the bit stream is speech to be further transmitted to a speech codec (not shown). The control unit 314 performs internal control tasks by controlling different units. Furthermore, the control unit 314 estimates 420 the signalling requirements, converts 432 the control information 116 into a format suitable for the second radio system 120, and forms the data packets that include the control information 116.

In transmission, the channel codec 312 codes the bit stream of the different logical channels, and a multiplexer 310 forms the bit stream from the logical channels. A modulator further 308 modulates the digital signals with a scrambling code, for instance.

The functional entity formed by the channel estimator 320, the demodulator 318, the demultiplexer 316, the channel codec 312, the multiplexer 310, the modulator 308, and the control unit 314 are included in the processor 332 and can be implemented with software. Some functions, however, can be implemented with an ASIC (Application Specific Integrated Circuit) application.

The user equipment 130 is configured to be in connection with more than one radio system. Typically, this requires that the transceiver 334 be capable of generating the required frequencies, which may be different in different systems, and that the digital part of the equipment be capable of coding and de-coding the possibly different signal forms of different systems.

Even though the invention is described above with reference to an example according to the accompanying drawings, it is clear that the invention is not restricted thereto but it can be modified in several ways within the scope of the appended claims.

1. A data transfer method in a mobile communication system comprising a first radio system and a second radio system operationally connected to the first radio system, and user equipment operationally connected to the first radio system and the second radio system, the method comprising the steps of:
generating control information for radio resource control of a first radio system; and
signalling at least a portion of the control information between a user equipment and a first radio system, using a second radio system.

2. The method of claim 1, further comprising signalling the at least a portion of the control information from the user equipment to the first radio system, using the second radio system.

3. The method of claim 1, further comprising signalling the at least a portion of the control information from the first radio system to the user equipment, using the second radio system.

4. The method of claim 1, further comprising controlling downlink radio resources of the first radio system, using the at least a portion of the control information.

5. The method of claim 1, further comprising using the at least a portion of the control information for controlling at least one function selected from a group comprising:
beam forming
transmitter diversity adjustment
MIMO channel adjustment
power control
data rate adjustment
prioritisation of users
routing allocation
multi-user scheduling
space-time modulation
modulation and coding adjustment
ARQ process control
handover control.

6. The method of claim 1, further comprising determining signalling requirements before signalling the at least a portion of the control information; and
selecting the second radio system for signalling, based on the signalling requirements.

7. The method of claim 1, wherein the step of generating the control information further comprises:
transmitting a signal from the first radio system to the user equipment;
performing a measurement on the signal in the user equipment; and
forming the at least a portion of control information in the user equipment, using the measurement.

8. The method of claim 1, wherein the step of signalling the at least a portion of the control information further comprises:
converting the at least one portion of the control information into a format suitable for the second radio system in order to provide a converted portion of the control information;
transmitting the converted portion of the control information from the user equipment to the second radio system;
receiving the converted portion of the control information in the second radio system;
delivering the converted portion of the control information from the second radio system to the first radio system; and
re-converting the converted portion of the control information into a format suitable for the first radio system.

9. The method of claim 1, further comprising signalling the at least a portion of the control information from the user equipment to the first radio system, using an uplink feedback channel of the second radio system.

10. The method of claim 1, further comprising signalling the at least a portion of the control information, using packet switched data transfer.

11. The method of claim 1 further comprising: generating control information for radio resource control of the second radio system;
signalling at least a portion of the control information for the radio resource control of the second radio system, using the second radio system; and
controlling the radio resources of the mobile communication system, using a portion of the control information for the radio resource control of the first radio system, and the portion of the control information for the radio resource control of the second radio system.

12. The method of claim 1, further comprising generating control information including at least one element selected from a group comprising:
a transmit antenna weight
a channel impulse response
a filtered channel impulse response
a signal-to-noise ratio
a signal-to-interference ratio
a signal-to-interference-and-noise ratio
a message associated with acknowledgement of reception
a channel quality indicator.

13. A mobile communication system comprising:
a first radio system comprising a primary base station for providing radio resources for the first radio system;
a second radio system operationally connected to the first radio system, the second radio system comprising a signal base station for providing radio resources for the second radio system;
user equipment comprising a transceiver for radio transmission and reception with the first radio system and the second radio system;
a generator for generating control information for radio resource control of the first radio system; and
the transceiver and the signal base station are configured to signal at least a portion of the control information between the user equipment and the first radio system.

14. The mobile communication system of claim 13, wherein the generator is configured to generate the control information in the user equipment for the radio resource control of the first radio system; and
wherein the transceiver and the signal base station are configured to signal the at least a portion of the control information from the user equipment to the first radio system.

15. The mobile communication system of claim 13, wherein the generator is configured to generate the control information in the first radio system for the radio resource control of the first radio system; and
wherein the signal base station is configured to signal the at least a portion of the control information to the user equipment.

16. The mobile communication system of claim 13, further comprising a primary controller connected to the first radio system and the second radio system for controlling downlink radio resources of the first radio system using the at least a portion of the control information.

17. The mobile communication system of claim 13, wherein the primary controller is configured to control at least one of the functions in the following group, using the portion of the control information:
beam forming
transmitter diversity adjustment
MIMO channel adjustment
power control
data rate adjustment
prioritisation of users
routing allocation
multi-user scheduling
space-time modulation
modulation and coding adjustment
ARQ process control
handover control.

18. The mobile communication system of claim 13, further comprising an estimator connected to the generator in the user equipment for determining signalling requirements; and
wherein the estimator is configured to select the second radio system for signalling, based on the signalling requirements.

19. The mobile communication system of claim 13, wherein the primary base station is configured to transmit a signal to the user equipment;
wherein the user equipment comprises a measurement unit connected to the generator for performing a measurement on the signal; and
wherein the generator is configured to form the control information using the measurement.

20. The mobile communication system of claim 13, wherein the user equipment comprises a converter connected to the generator for converting a portion of the control information between a format of the first radio system and a format of the second radio system, providing a converted portion of the control information;
wherein the transceiver is configured to transmit the converted portion of the control information to the second radio system;
wherein the signal base station is configured to receive the converted portion of the control information;
wherein the mobile communication system further comprises a gateway connected to the first radio system and the second radio system for delivering the converted portion of the control information from the second radio system to the first radio system; and
the mobile communication system further comprises a converter connected to the first radio system and the second radio system for re-converting the converted portion of the control information into a format suitable for the first radio system.

21. The mobile communication system of claim 13, wherein the transceiver and the signal base station are configured to signal the at least a portion of the control information using an uplink feedback channel of the second radio system.

22. The mobile communication system of claim 13, wherein the transceiver and the signal base station are configured to signal the at least a portion of the control information using packet switched data transfer.

23. The mobile communication system of claim 13, wherein
the generator is configured to generate control information for the radio resource control for the second radio system; and
wherein the transceiver and the signal base station are configured to signal at least a portion of the control information for the radio resource control for the second radio system from the user equipment to the second radio system; and
the mobile communication system comprises overall controller for controlling the radio resources of the mobile communication system using at least a portion of the control information generated for the first radio system and at least a portion of the control information generated for the second radio system.

24. The mobile communication system of claim 13, wherein the portion of the control information includes at least one element selected from a group comprising:
a transmit antenna weight
a channel impulse response
a filtered channel impulse response
a signal-to-noise ratio
a signal-to-interference ratio
a signal-to-interference-and-noise ratio
a message associated with acknowledgement of reception
a channel quality indicator.

25. A mobile communication system comprising:
generating means for generating control information for radio resource control of a first radio system; and
signalling means for signalling at least a portion of the control information between a user equipment and a first radio system, using a second radio system.

26. The mobile communication system of claim 25, wherein the signalling means signals the at least a portion of the control information from the user equipment to the first radio system, using the second radio system.

27. The mobile communication system of claim 25, wherein the signalling means signals the at least a portion of the control information from the first radio system to the user equipment, using the second radio system.

28. The mobile communication system of claim 25, further comprising a control means for controlling downlink radio resources of the first radio system using at least a portion of the control information.
